(19) United States
(12) Patent Application Publication
(10) Pub. No.: US 2020/0164267 A1
(43) Pub. Date: May 28, 2020

(54) BOARD GAMES TO PROMOTE SPEECH AND LANGUAGE DEVELOPMENT

(71) Applicant: Lori Franklin, Paterson, NJ (US)

(72) Inventor: Lori Franklin, Paterson, NJ (US)

(21) Appl. No.: 16/698,883

(22) Filed: Nov. 27, 2019

Related U.S. Application Data
(60) Provisional application No. 62/772,072, filed on Nov. 27, 2018.

(51) Int. Cl. A63F 3/04; G09B 17/00

(52) U.S. Cl. CPC A63F 3/0423; A63F 2003/00391; G09B 17/00; A63F 3/0402

(57) ABSTRACT

The invention relates to devices and methods designed to promote speech and language development and, in particular, learning upper and lower case letters, shapes, colors, numbers and phonemes to improve articulation. Phonemes, which form one of the basic building blocks of speech, are distinguishing speech sounds that differentiate one word from another, e.g. the sounds “d” and “t” in the words “bid” and “bit” and are the smallest phonetic units that can carry meaning.

### BACKGROUND OF THE INVENTION

### Field of the Invention

The field of the invention relates to devices and methods designed to promote speech and language development among young children, in particular, learning upper and lower case letters, shapes, colors, numbers and phonemes to improve articulation. Phonemes, which form one of the basic building blocks of speech, are distinguishing speech sounds that differentiate one word from another, e.g. the sounds “d” and “t” in the words “bid” and “bit” and are the smallest phonetic units that can carry meaning (Encarta® World English Dictionary ©2009 Microsoft Corp.)

### Description of the Related Art

From a U.S. Pat. No. 8,287,338, titled “Game Apparatus for Learning”, a game apparatus for learning is known containing a rotary plate located between a base plane of a base part and an upper plate of a housing main body, axially connected to a driving body installed in the base part such that the rotary plate is rotatable, a plurality of insertion grooves, into which learning assembly blocks are inserted, are respectively formed in the rotary plate and the upper plate in a circumferential shape.

A U.S. Pat. No. 8,146,920, titled “Tile game apparatus and method for learning alphabet-based symbolic notation” teaches a tile-based game used for teaching symbolic notation corresponding to alphabetical notation, such as found in music and code or sign language, by having players attempt to spell word with the symbolic notations that appear on one side of the tiles. Players are given points for the correct assembly or deciphering of a word with the tiles and check for correct answers by viewing the corresponding alphabetical notations on an opposite side of the tiles.

A U.S. Pat. No. 5,722,834, titled “Method of playing a learning tree board game”, teaches a learning tree board game which includes a game board having a picture of a tree, a sand box area on a lower left hand corner, a green area on a lower right hand corner and a plurality of identifiable indicia upon the picture of a tree. A plurality of playing tokens are provided, in which one for each of the game players is placed on the sand box area at the beginning of the game and then on one of the identifiable indicia during the play of the game. A deck of cards are used, in which each card has indicia thereon which matches up with one of the identifiable indicia upon the picture of a tree of the game board.

A U.S. Pat. No. 4,034,980, titled “Magnetic game board and playing pieces”, describes a game board having two playing surfaces each symmetrically divided into a plurality of like regions which are arranged to form rows, columns, and diagonals of the regions in the fashion of a checkerboard. The game is played by moving pieces having bar magnets therein about the regions. Some regions have bar magnets thereunder which either repel or attract the pieces. The game provides for automatic, in place, flipping of pieces which are repelled and for reprogramming of the positions of the magnets in the board.

The above mentioned prior art does not teach a game that comprises a board that assembles from magnetic pieces and assembles into the shape of phonemes as described in the patent present application.

### BRIEF SUMMARY OF THE INVENTION

It is an object of the present invention to provide a means of practicing target phoneme(s) to improve articulation of young children, to learn colors (primary and secondary), to learn shapes (circle, square, triangle, oval, trapezoid, hexagon, octagon), and to learn letters (upper and lower case).

Also the game boards can be used to learn the alphabet (upper case on front, lower case on back) of each board. The tasks include letter identification, verbal label of letters, and/or sound to letter, as well as recognition of letter sound at the beginning and/or end of single words consonant-vowel-consonant sound sequences i.e., words like cat, can, fun, etc. In that case the age of young children ranges from 2 to 6 years old.

Activities of young children for the age group above six (6+ till 10 years old): word and/or picture cards to practice target sound(s) in isolation, initial, final, and medial positions of words, consonant blends, phrases, sentences.
Participant rolls dice, spinner, pick a number box, etc.
Participant moves indicated number of spaces
Participant picks the number of cards indicated that his/her marker lands on
Participant says words for the cards picked.

The following levels of the game are designed: initial, medial, and final. The following technics are used in the game: consonant blends, phrases and sentences. A Mediator is a Therapist, a Teacher and/or a Parent.

Clients, at a level of self monitoring carry over correct sound production in connected spontaneous speech.

The objective of the invention is achieved by observing the following rules: Individual shapes with magnets of different colors should be connected together. Game board length and configuration is depended on how shapes are connected.

In case of premade game boards one of each letter of the alphabet is used, one side upper case, and flip side lower case. Plastic shapes are together in the form of the phoneme being addressed to form a playing board.

In case of the articulation game the plastic shapes should be connected to form the target phoneme being addressed (held together by magnets)—follow same directions as for letter boards.

The letter board should be used that corresponds with the phoneme (sound) that is being addressed.

Dice, number cards, etc. should be used to determine number of spaces to move.

Player moves game piece and follows directions written in the space he/she lands on i.e. pick ______ number of cards. Player reads that number of cards, which will contain the target phoneme.

Color and/or Shapes: Stack cards or mix in bag/box. Player picks a card, name the color, name the shape, or both (depending on concept focus). If correct, find the same shape and/or color to connect by magnets. If incorrect the next player goes. Player with the most colored shapes connected wins.

Letter ID: Use lettered game boards as flash card. Letters can be placed in order on the floor. Scatter letters randomly, name a letter; the player selects the corresponding letter card. For beginners start with lower case letters. When reading or looking at words in books, most of the letters will be lower case.

### BRIEF DESCRIPTION OF SEVERAL VIEWS OF THE DRAWINGS

The patent or application file contains at least one drawing executed in color. Copies of this patent or patent application publication with color drawing(s) will be provided by the Office upon request and payment of the necessary fee.

Details and features of the board games will become more apparent from accompanying drawings in which:

FIG. 1 shows a game board that assembles from magnetic pieces in a different shape displaying numbers in different colors and connected together in a shape of a consonant “c”;

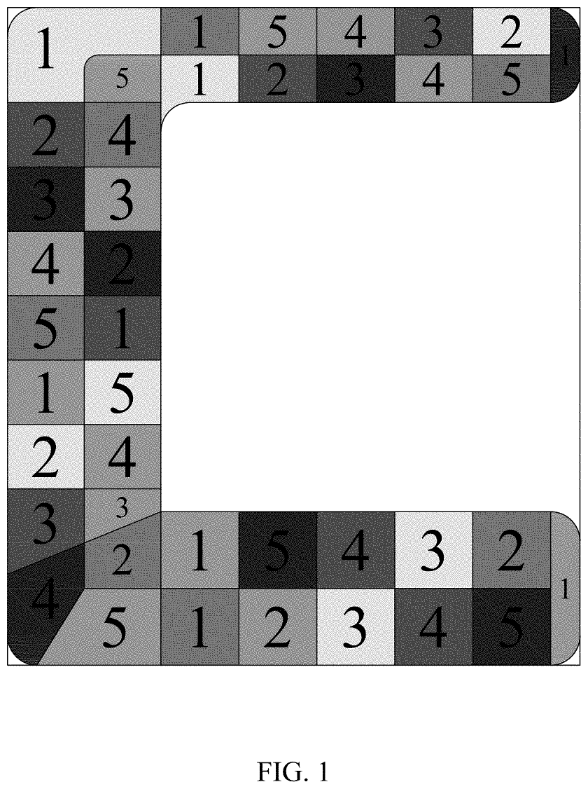

FIG. 2 shows a game board that assembles from magnetic pieces in a different shape displaying numbers in different colors and connected together in a shape of a consonant “h”;

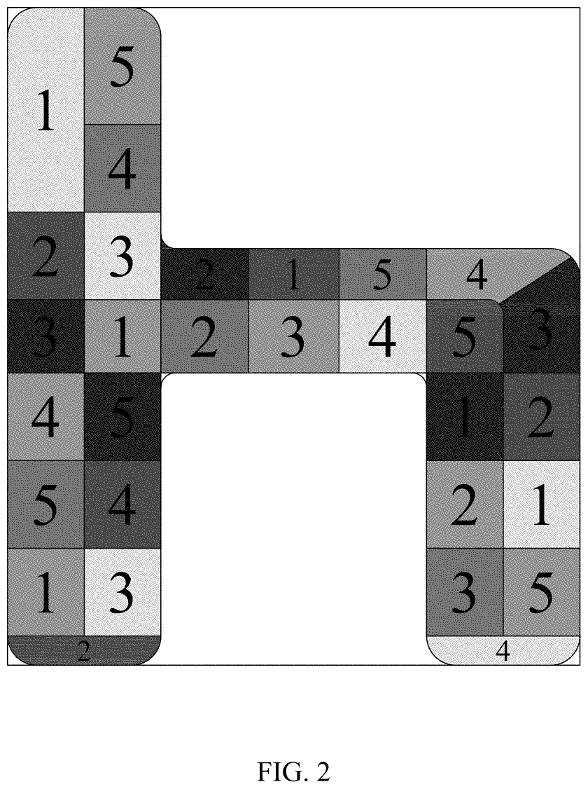

FIG. 3 shows a game board that assembles from magnetic pieces in a different shape displaying numbers in different colors and connected together in a shape of a consonant “l”;

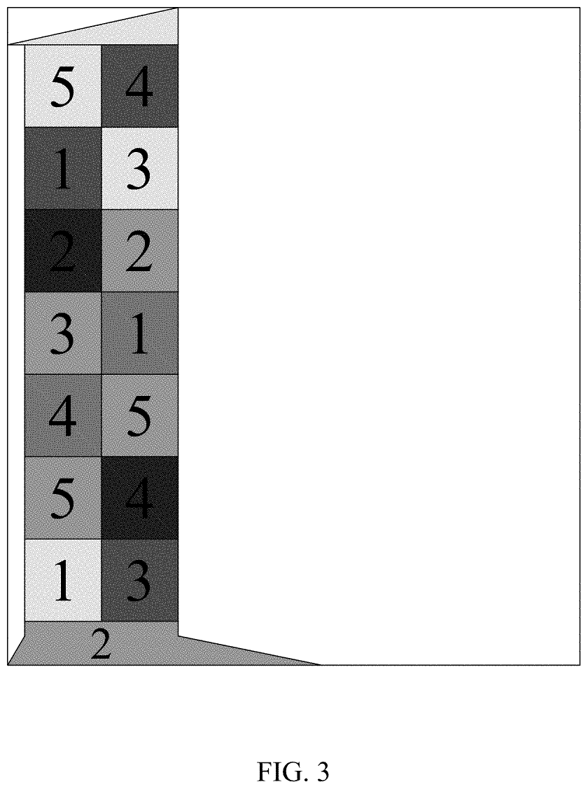

FIG. 4 shows a game board that assembles from magnetic pieces in a different shape displaying numbers in different colors and connected together in a shape of a consonant “k”;

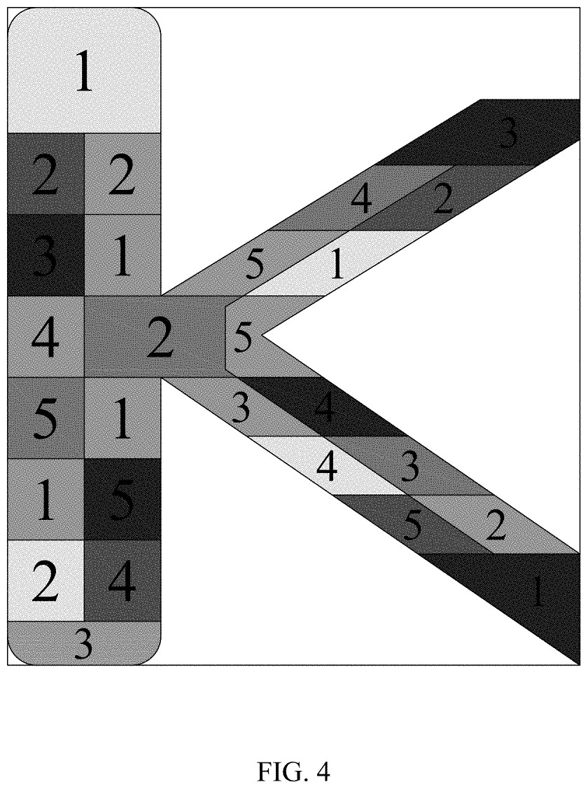

FIG. 5 shows a game board that assembles from magnetic pieces in a different shape displaying numbers in different colors and connected together in a shape of a consonant “n”;

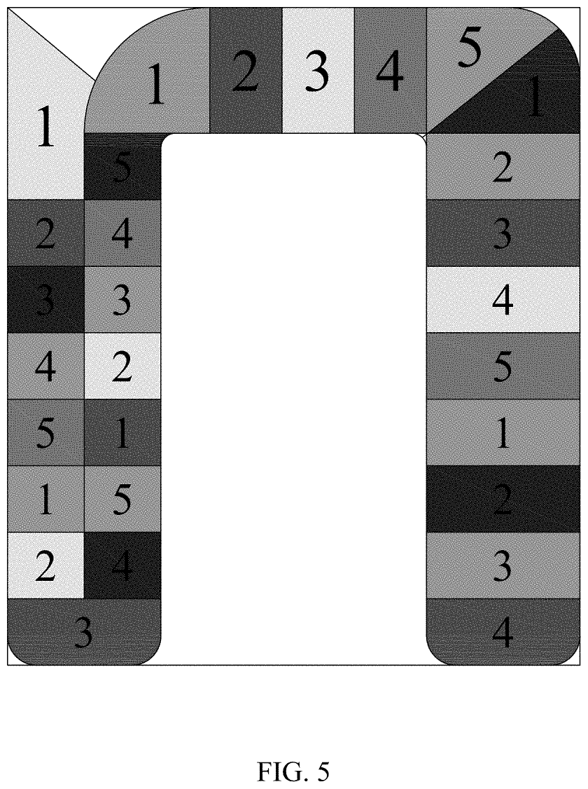

FIG. 6 shows a game board that assembles from magnetic pieces in a different shape displaying numbers in different colors and connected together in a shape of a consonant “p”;

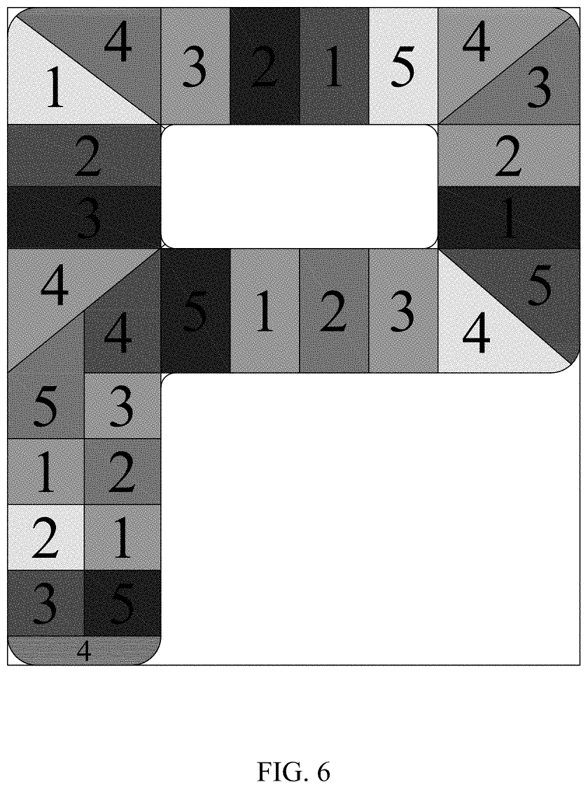

FIG. 7 shows a game board that assembles from magnetic pieces in a different shape displaying numbers in different colors and connected together in a shape of a consonant “r”;

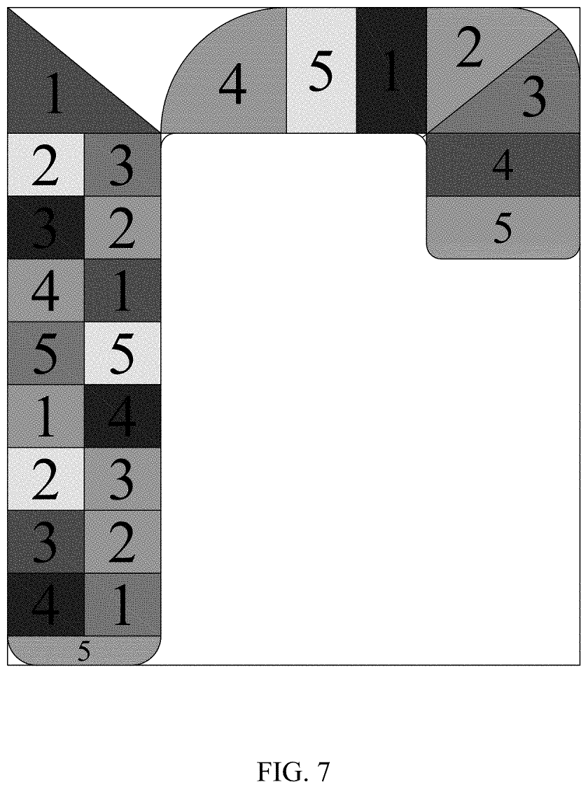

FIG. 8 shows a game board that assembles from magnetic pieces in a different shape displaying numbers in different colors and connected together in a shape of a consonant “s”;

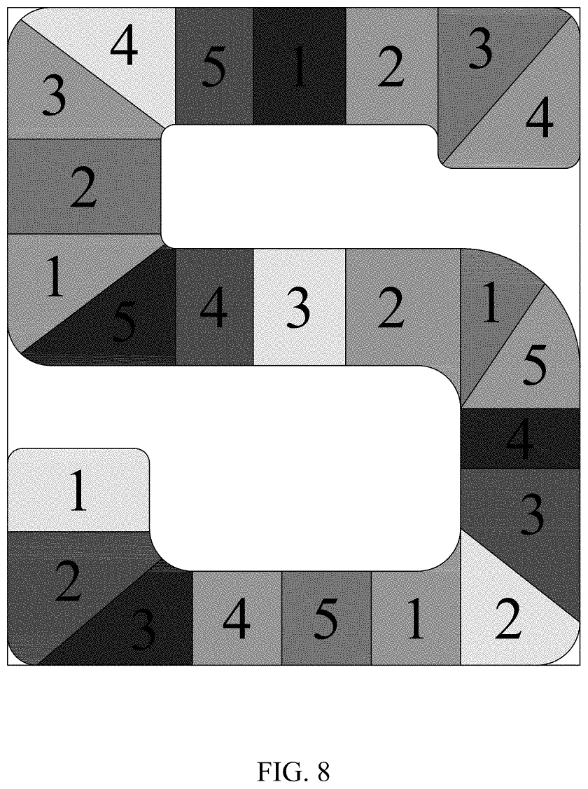

FIG. 9 shows a game board that assembles from magnetic pieces in a different shape displaying numbers in different colors and connected together in a shape of a consonant “t”;

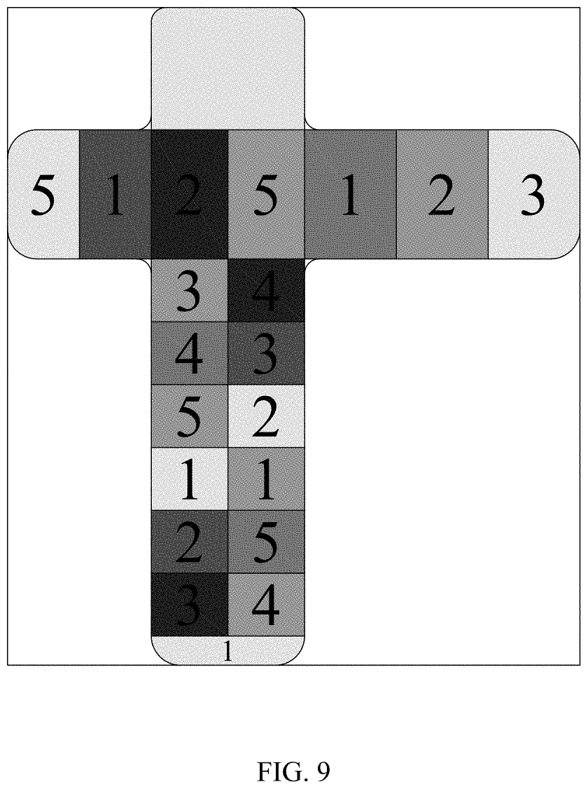

FIG. 10 shows a game board that assembles from magnetic pieces in a different shape displaying numbers in different colors and connected together in a shape of a consonant “m”;

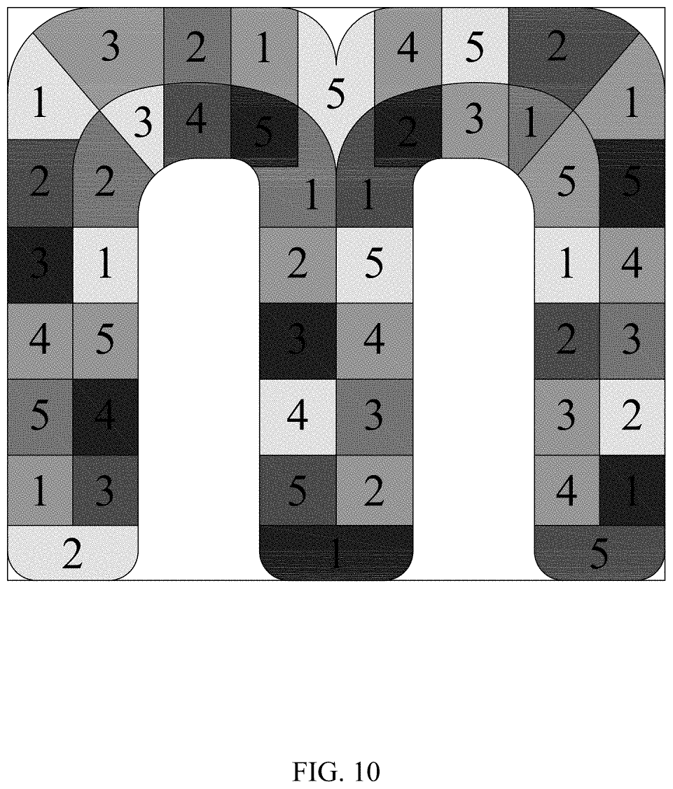

FIG. 11 shows a game board that assembles from magnetic pieces in a different shape displaying numbers in different colors and connected together in a shape of a consonant “w”; and

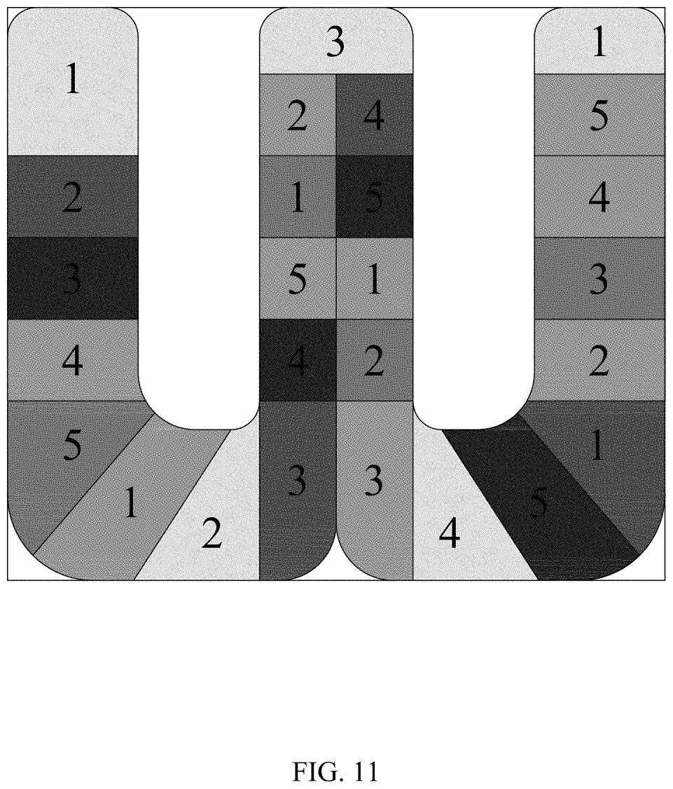

FIG. 12 shows a game board that assembles from magnetic pieces in a different shape displaying numbers in different colors and connected together in a shape of a consonant “z”.

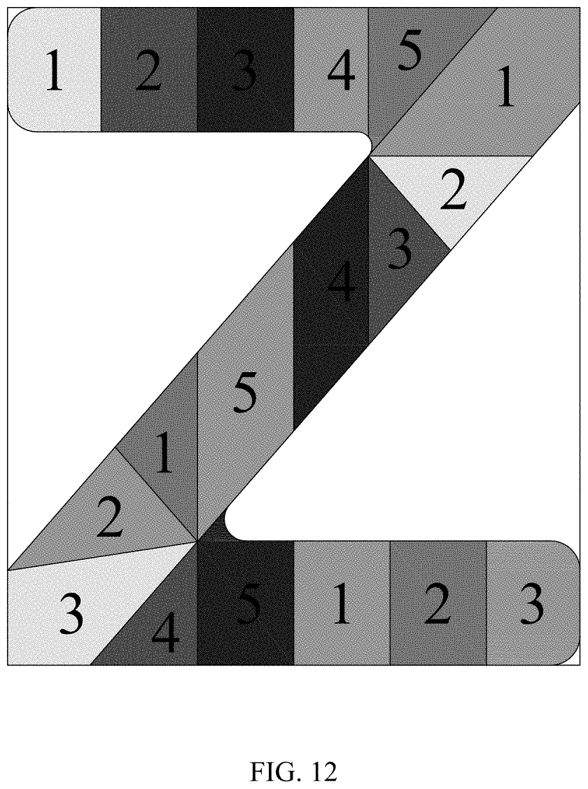

1. A device for promoting speech and language development among young children comprising
a game board,
magnetic pieces,
cards,
number box, and
plastic shapes.

2. The device according to claim 1, wherein the magnetic pieces represent lower and upper case letters, shapes, colors, numbers and phonemes.

3. The device according to claim 1, wherein a board game comprises a board that is assembled from magnetic pieces into a shape of phonemes.

4. The device according to claim 1 wherein the device is used for learning upper and lower case letters, primary and secondary colors, numbers and phonemes in order to improve articulation, for practicing target phoneme(s), to improve articulation of young children, to learn shapes including circle, square, triangle, oval, trapezoid, hexagon, octagon, and to learn the alphabet, upper case letters on the front, and lower case letters on the back of each board.

5. A method of promoting speech and language development among young children, including steps of
letters identification,
verbal label of letters,
pronunciation of letters,
recognition of letters sound at the beginning and/or at the end of single words, consonant-vowel-consonant sound sequences, including words like cat, can, and fun.

6. The method of claim 5, wherein the board game has the initial, medial, and final level.

7. The method of claim 5, wherein the age of young children ranges from 2 to 6 years old.

8. The method of claim 5, wherein activities of young children, the age above 6 till 10 years old, include use of a word and/or picture cards to practice target sounds in isolation, initial, final, and medial positions of words, consonant blends, phrases, sentences, wherein the method includes:
rolling dice, spinner, by a participant
picking a number box,
moving indicated number of spaces, and
picking the number of cards indicated that his/her marker lands on says words for the cards picked.

9. The method of claim 5, wherein consonant blends, phrases and sentences are used in the game.

10. The method of claim 5, wherein a Mediator is a Therapist, a Teacher and/or a Parent.

11. The method of claim 5, wherein Clients, at a level of self-monitoring, carry over correct sound production in connected spontaneous speech.

12. The method of claim 5, wherein individual shapes with magnets of different colors should be connected together, wherein game board length and configuration is depended on how shapes are connected, wherein in case of premade game boards one of each letter of the alphabet is used, one side upper case, and flip side lower case, wherein plastic shapes are together in the form of the phoneme being addressed to form a playing board, wherein in case of the articulation game the plastic shapes should be connected to form the target phoneme being addressed which is held together by magnets, wherein one should follow the same directions as for a letter board game.

13. The method of claim 12 wherein a letter board should be used that corresponds to the phoneme, sound that is being addressed, wherein dice, number cards, and others, should be used to determine number of spaces to move, wherein a player moves game pieces and follows directions written in the space he/she lands on pick number of cards, wherein a Player reads that number of cards which will contain the target phoneme.

14. The method of claim 5, wherein in case of color and/or shape games stack cards or mix in bag/box are used, wherein a Player picks a card, name the color, name the shape, or both depending on concept focus, wherein if correct, the Player finds the same shape and/or color to connect by magnets, and if incorrect the next Player plays, and wherein the Player with the most colored shapes connected wins.

15. The method of claim 5, wherein in case of a letter ID game, letter game boards are used as flash cards, wherein letters can be placed in order on the floor and than scattered randomly, wherein each letter is named, wherein a Player selects the corresponding letter card.

16. The method of claim 15, wherein for beginners a game should start with lower case letters.
